(19) United States
(12) Patent Application Publication
(10) Pub. No.: US 2009/0259585 A1
(43) Pub. Date: Oct. 15, 2009

(54) EVENT-DRIVEN CREDIT OFFERS

(76) Inventors: Kenneth Beirne, Mount Vernon, NY (US); Robert Stone, Cos Cob, CT (US); Shari Booth, Charlotte, NC (US); Debra Gangelhoff, York, SC (US); John Molnar, Trumbull, CT (US); Daniel Loskove, Woodmere, NY (US)

Correspondence Address: BUCKLEY, MASCHOFF & TALWALKAR, LLC;GENERAL ELECTRIC COMPANY, 50 LOCUST AVENUE, NEW CANAAN, CT, 06840, US

(21) Appl. No.: 12/099,853

(22) Filed: Apr. 9, 2008

(51) Int. Cl. G06Q 40/00

(52) U.S. Cl. 705/38

(57) ABSTRACT

A system may include detection of an event indicating a potential future credit need, identification of a person based on data associated with the event, determination of a credit product based on the detected event, and determination of whether the person qualifies for the credit product based on a creditworthiness of the person. In some aspects, the determination of whether the person qualifies for the credit product includes determination of a creditworthiness requirement associated with the credit product, and determination of whether the creditworthiness of the person satisfies the creditworthiness requirement.

### FIELD

Some embodiments relate to electronic commerce systems. More specifically, some embodiments concern selective credit screening and offer generation based on detected events.

### BACKGROUND

Businesses may benefit from establishing credit accounts with their customers. Credit accounts may promote brand loyalty, increase customer expenditures, and provide additional income to a business via associated fees and charges. Examples of these accounts include lines of credit and “private label” credit cards branded by a business and issued by a credit card issuer. Each of the foregoing credit products may be associated with any number of similar or different terms and conditions, such as spending limit, expiration date, interest rate, repayment terms, etc.

Prior to offering a credit product to a customer, it is desirable to determine the customer's creditworthiness. The creditworthiness may be used to determine whether any credit product should be offered, which credit product should be offered, and/or the terms and conditions of an offered credit product. A creditworthiness determination may consist of forwarding customer information to a credit bureau along with instructions for performing a creditworthiness determination. In response, the credit bureau returns a credit score or other indicator of the customer's creditworthiness.

To justify the costs of determining a customer's creditworthiness, the customer is preferably associated with a greater-than-average likelihood of accepting any resulting credit offer. However, the cost of identifying such a customer may outweigh any cost advantage attributable to the increased likelihood. Accordingly, a business may choose to perform creditworthiness checks of and extend offers to a random or lightly-filtered sample of customers.

From a customer's standpoint, obtaining a credit account can be time-consuming and otherwise inefficient. The customer must identify an appropriate offer from a myriad of offers to which the customer is exposed (e.g., 0% interest cards, rewards cards, mortgage refinancing), complete any forms associated with the identified offer, and wait for a determination. In this regard, the volume of offers received by a typical customer further reduces the likelihood that any one offer will be accepted.

What is needed is a system to efficiently identify a potential credit customer and to efficiently deliver an appropriate credit offer to the customer.

### BRIEF DESCRIPTION OF THE DRAWINGS

FIG. 1 is a diagram of a network topology according to some embodiments.

FIG. 2 is a flow diagram of a process according to some embodiments.

FIG. 3 is a block diagram of a system according to some embodiments.

FIGS. 4 through 6 comprise a flow diagram of a process according to some embodiments.

### SUMMARY

Some aspects relate to a system, method, apparatus, computer-readable medium, and means to detect an event indicating a potential future credit need, identify a person based on data associated with the event, determine a credit product based on the detected event, and determine whether the person qualifies for the credit product based on a creditworthiness of the person. The event may comprise one or more of a purchase of an instruction guide, an information inquiry, completion of a design, a service order, or a request for quote.

In some aspects, the determination of whether the person qualifies for the credit product includes determination of a creditworthiness requirement associated with the credit product, and determination of whether the creditworthiness of the person satisfies the creditworthiness requirement. Offering the credit product to the person may include initiating mailing of a mail piece to the person, wherein the mail piece includes a firm offer of the credit product.

The claims are not limited to the disclosed embodiments, however, as those in the art can readily adapt the description herein to create other embodiments and applications.

### DETAILED DESCRIPTION

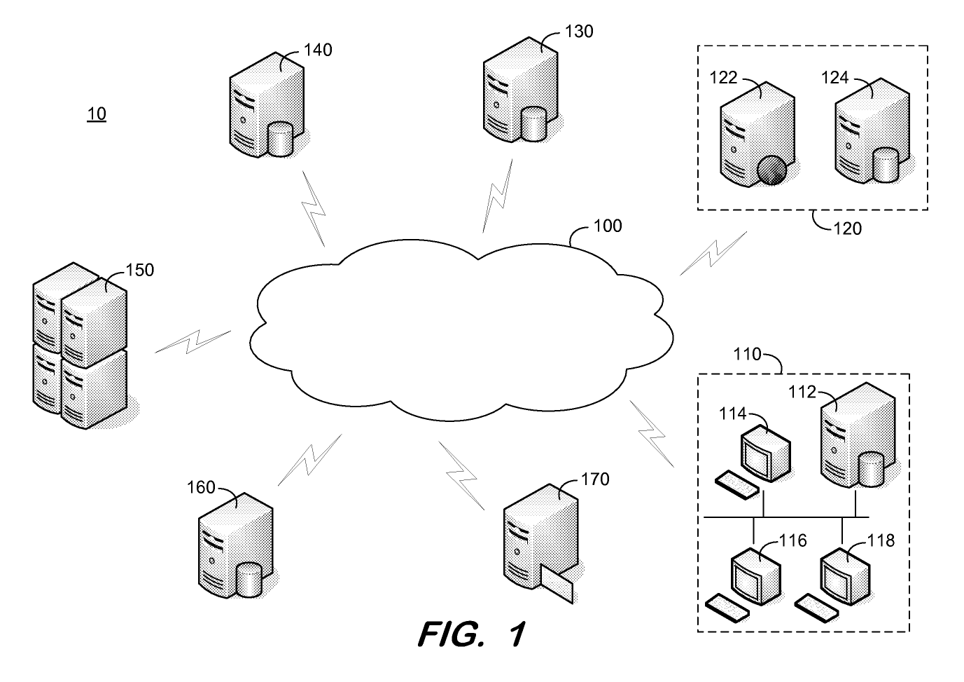

FIG. 1 is a block diagram of system 10 according to some embodiments. Each device of system 10 is capable of communication with network 100, which may comprise the Internet as well as any number of other public and/or private networks. Two or more of devices of system 10 may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

System 10 includes network 110, which may be physically located within a retail store. Network 110 includes data server 112 and terminals 114 through 118. Terminals 114 through 118 may comprise cash registers, kiosks and/or other input devices which interoperate with data server 112 to provide electronic functions to facilitate retail commerce. These functions may include but are not limited to payment processing, item price and information lookup, order placement, and inventory tracking. Network 110 may comprise more devices than those illustrated in FIG. 1 and may be linked to other retail store networks and/or a central system via an unshown secure communication link.

Network 120 may support online commerce. In particular, Web server 122 may support HyperText Transfer Protocol (HTTP) communication with Web clients. Such communication may provide a website for providing product information and responding to customer inquiries. Web server 122 may query data server 124 for information required to provide such a website. Data server 124 may also support online transaction processing (OLTP) and provide various reporting features that are or become known. Network 120 may also comprise devices in addition to those illustrated.

Data server 130 represents any accessible data source. Server 130 may be operated by any type of information provider. The information may track consumer activity, address data and or any other data that may be suitably used in conjunction with some embodiments. The data of server 130 may be accessed via subscription or another mechanism.

Server 140 may, in some embodiments, provide data processing functions to facilitate event-driven credit offers as will be described in detail below. In this regard, server 140 may aggregate data from various sources (e.g., network 110, network 120 and server 130), extract and format the data according to a protocol, apply rules to the data, perform deduplication, etc.

A credit issuer may operate application servers 150 in some embodiments. The credit issuer may provide a credit product to be offered to customers. Application servers 150 may execute a suite of business applications to provide business functions to the credit issuer. According to some embodiments, a same entity operates servers 140 and 150.

Server 160 may provide determinations of creditworthiness. As described in the present Background, a credit bureau may operate server 160 to receive customer information along with instructions for performing a creditworthiness determination. In response, server 160 returns an “Approve” or “Deny” designation, a credit score, a list of all customers who have met a specified creditworthiness requirement, and/or another indicator of creditworthiness.

Mailpiece server 170 may receive information to create and transmit a mailing to a person. The mailing may include an offer of a credit product generated according to some embodiments. The mailing may further include terms and conditions, graphics, and forms specified by the issuer of the credit product and/or a business with which the credit product is branded.

Each of elements 110 through 160 may include any number of disparate hardware and/or software elements, some of which may be located remotely from one another. Functions attributed to one element may be performed by one or more other elements in some embodiments. The elements of system 10 may communicate with one another (and with other non-illustrated elements) over any suitable communication media and protocols that are or become known.

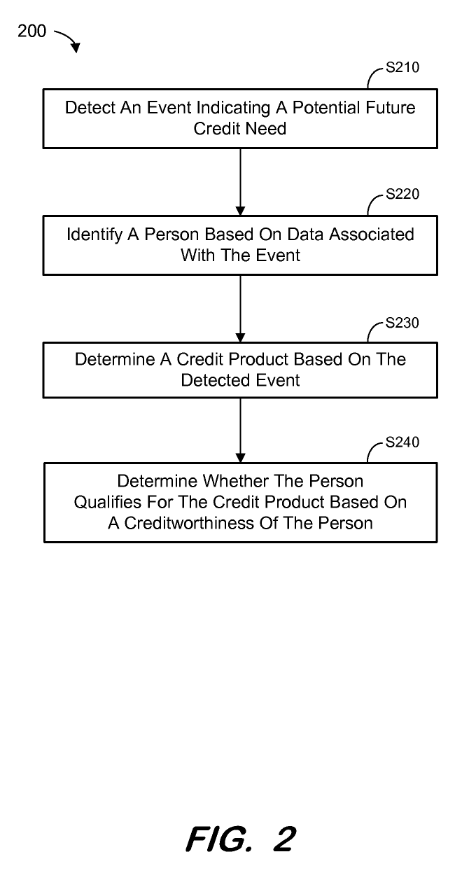

FIG. 2 is a flow diagram of process 200 according to some embodiments. Some embodiments of process 200 may provide credit offers based on detected events. System 10 may execute process 200 in some embodiments.

Process 200 and all other processes mentioned herein may be embodied in processor-executable program code read from one or more of a computer-readable medium, such as a floppy disk, a CD-ROM, a DVD-ROM, a Zip™ disk, a magnetic tape, and a signal encoding the process, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, an event is detected at S210. The event indicates a potential future credit need. More specifically, the event may comprise an occurrence which increases the likelihood that a particular person will desire a credit product in the future. In one example of S210, a customer purchases a kitchen remodeling instruction guide at the retail store of network 110, and the purchase is detected by server 140. Another example includes a customer submitting a request for a quote to network 120 via a Web browser. Server 140 may also detect this request at S210.

Embodiments are not limited to the events described herein. The event may include an information inquiry, completion of a design, an address change, a service order, etc. Any event indicating a potential future credit need may be detected in some embodiments of S210.

Detection of the event at S210 may comprise receiving data (e.g., from network 110 or network 120) and analyzing the data to determine whether a specified type of event has occurred. The data may be further analyzed at S220 to determine a person associated with the event. According to some embodiments, the determined person is the particular person who may desire a credit product in the future due to the detected event.

A credit product is determined based on the detected event at S230. Examples of credit products may include lines of credit and/or credit cards with various associated spending limits, interest rates, and repayment rules. Embodiments are not limited to these types of products. According to some embodiments of S230, the credit product is determined based on one or more of a project cost associated with the detected event, an expected duration of a project associated with detected event, an expected profit associated with the detected event, and any other factor relating to the detected event.

Next, at S240, it is determined whether the person qualifies for the determined product based on a creditworthiness of the person. For example, the determined credit product may be associated with a creditworthiness requirement. S240 may therefore comprise determining whether the person meets this creditworthiness requirement.

In a more specific example, the creditworthiness requirement for a particular credit product may comprise a minimum credit score. S240 may, in such an example, comprise determining the credit score (i.e., the creditworthiness) of the person and determining whether this credit score meets or exceeds the required minimum credit score. Some embodiments of S230 may comprise forwarding the minimum credit score associated with the determined credit product and information associated with the person (e.g., address, date of birth, social security number) to server 160 of a credit bureau and receiving, in response, an indication of whether the person's credit score exceed the minimum credit score.

As will be described below, embodiments may further include automatic mailing of materials comprising the offer to the person. According to some embodiments, process 200 may comprise a batch job in which many events are detected, persons identified, credit products determined, and qualifications evaluated each process step.

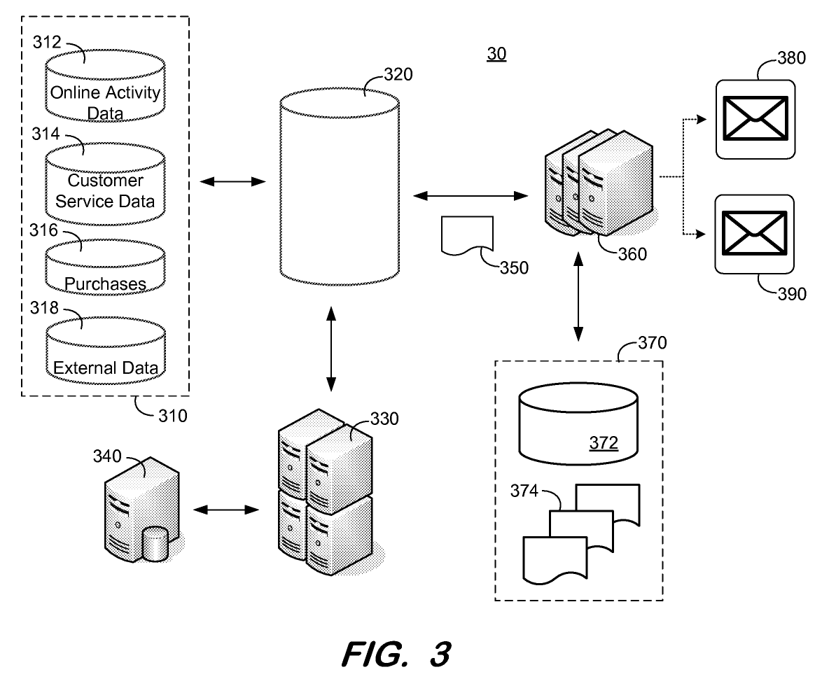

FIG. 3 is a block diagram of system 30 according to some embodiments. System 30 may execute process 200, but embodiments are not limited thereto. FIG. 3 does not necessarily illustrate a network topology of system 30 but is intended to illustrate data flow and general functional interrelationships. In some embodiments, system 30 is implemented by the network topology of FIG. 1.

System 30 includes data sources 310. Data sources 310 are characterized as online activity data 312, customer service data 314 (e.g., call center data), purchase data 316 and external data 318 (e.g., postal information indicating an address change). Embodiments are not limited to these four classes of data, and each of the data sources 310 may represent data collected and/or aggregated by one or more other data sources.

Data servicer 320 may comprise a provider of information, analytics and/or logistics services. Data servicer 320 may receive data from data sources 310 using any suitable communication protocol (e.g., subscription, periodic download, periodic upload, etc.). Specific functions of data servicer 320 according to some embodiments will be described below with respect to process 400.

Application servers 330 may be operated by a credit issuer to provide various business functions. In some embodiments, application servers 330 receive a prospect list from server 320 and forward the list to credit bureau 340. The prospect list may include information identifying several people and creditworthiness requirements associated with each person. The creditworthiness requirements may depend upon a credit product determined for each person. In some examples, all consumers to be screened for a particular product are associated with a same creditworthiness requirement. Application servers 330 may perform some processing on the prospect list prior to forwarding the list.

Credit bureau server 340 may receive the prospect list and determine, for each person in the prospect list, whether the person satisfies an associated creditworthiness requirement. The determinations may be returned to server 330 (e.g., as a list of only those persons who satisfy their associated creditworthiness requirement), and server 330 may create mailing list 350 of people who satisfy their associated creditworthiness requirement. The resulting mailing list 350 is transmitted from servers 330 to data servicer 320 and on to print production servers 360.

Print production servers 360 may access printing assets 370 to generate mailings based on list 350. Assets 370 may comprise image data 372 and text (e.g., disclosures, templates) data 374. In the illustrated embodiment, servers 360 may generate mail piece 380 which is integrated with a branded business mailing, or mail piece 390 which is a card issuer-branded mailing.

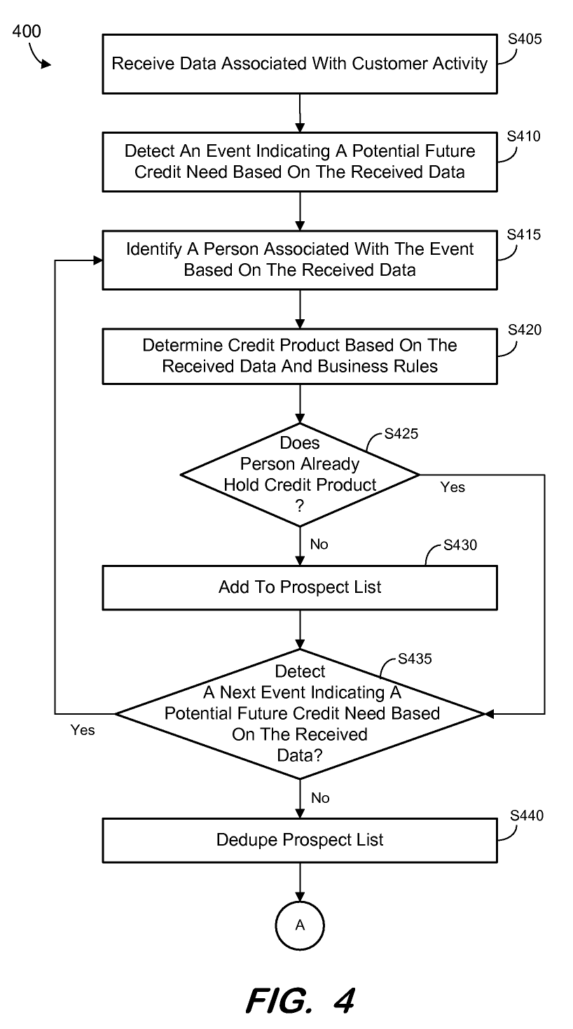

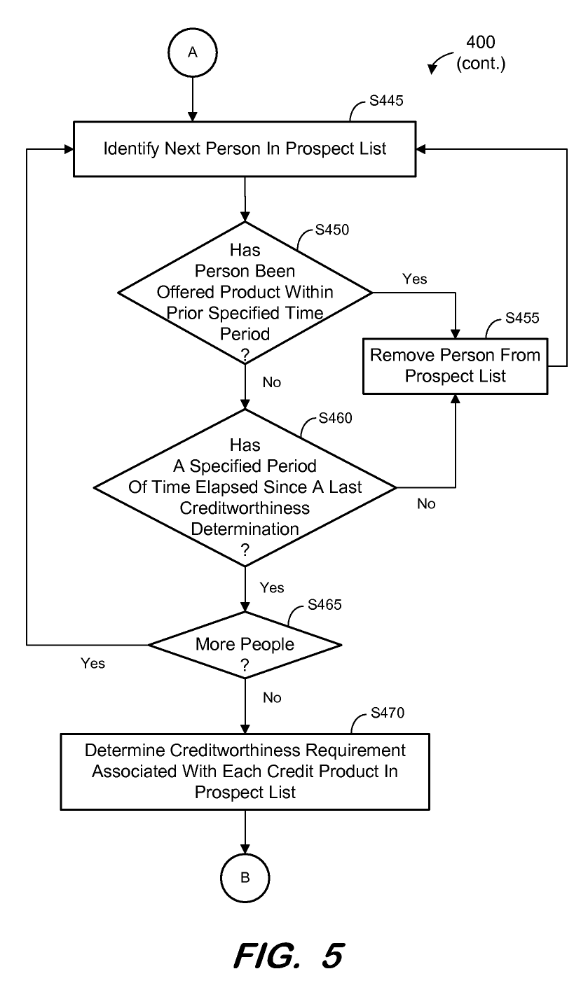

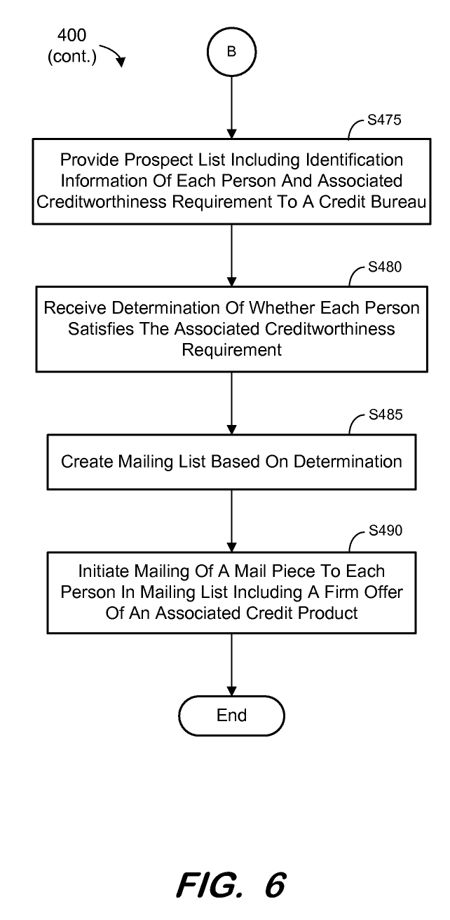

Process 400 of FIGS. 4 through 6 represents one process that may be performed by system 30. In some embodiments, system 10 performs process 400. Moreover, process 400 may comprise an implementation of process 200 described above.

Data associated with customer activity is received at S405. With respect to the system 30 embodiment, data servicer 320 may receive the data at S405 from data sources 310. The data may represent various types of customer activity. Reception of the data may be a continuous or periodic process.

An event is detected based on the received data at S410. As mentioned above, the event indicates a potential future credit need. Some embodiments of S410 include identifying a portion of the data which represents a single customer activity, and evaluating the identified data portion against multiple sets of data characteristics, with each set of characteristics representing an event.

Next, at S415, a person associated with the detected event is determined based on the received data. Continuing with the above example, servicer 320 may examine the identified data portion for an indication of a person with whom the event is associated. The indication may comprise a name, address, telephone number, account number, ID number, social security number and/or any other identifying information.

A credit product is determined at S420 based on the received data and on business rules. The rules may be provided to data server 320 from credit issuer 330. The rules may comprise logic which inputs certain fields of the identified data portion and outputs a particular credit product. For example, S420 may include estimating an amount of the future credit need and a duration of the future credit need based on the identified data portion. A credit product is then selected based on the estimated amount and duration.

At S425, it is determined whether the identified person already holds the determined credit product. Such a determination may include querying credit issuer 330. Flow continues to S430 if the determination is negative.

The identified person is added to a prospect list at S430 in association with the determined credit product. Flow proceeds from S430 to S435, or from S425 directly to S435 if the determination at S425 is positive. At S435, detection of a next event is attempted based on the received data. For example, an attempt is made to identify another portion of the received data which represents a customer activity, and to detect an event by evaluating the identified data portion against multiple sets of data characteristics representing respective events.

Flow returns to S415 and proceeds as described above if a next event is detected at S435. Accordingly, flow may cycle between S415 and S435 to add a plurality of people to the prospect list. Flow continues to S440 once no further events are detected at S435 based on the received data.

The prospect list is deduped at S440. According to some embodiments, data servicer 320 dedupes the prospect list at S440 using any method that is or becomes known. Some embodiments may perform deduplication at additional or other suitable points of process 200.

The prospect list may be processed further at S445 through S465. Such processing may be performed by one or both of data servicer 320 and card issuer 330 according to some embodiments.

A next person in the prospect list is identified at S445. The “next” person will be the first person in the prospect list at the first iteration of S445. As mentioned above, the prospect list associates the identified person with a credit product.

At S450, it is determined whether the person has been offered the credit product within a prior specified time period. For example, S450 may comprise determining whether the person has been offered the product within the previous six months. If so, the person is removed from the prospect list at S455 and flow returns to S445 to identify a next person in the prospect list.

Flow proceeds from S450 to S460 if the determination at S450 is negative. At S460, it is determined whether a specified period of time has elapsed since a last creditworthiness determination was performed with respect to the determined person. Flow returns to S455 to remove the person from the prospect list if the specified period (e.g., 30 days) has not elapsed.

S465 comprises a determination of whether the prospect list includes additional people who were not previously identified at S445. Flow returns to S445 if the determination is positive and proceeds to S470 if the determination is negative.

A creditworthiness requirement associated with each credit product in the prospect list is determined at S470. The creditworthiness requirement may specify a minimum standard that must be met in order to offer a credit product to a person with whom the credit product is associated in the prospect list.

The resulting prospect list is provided to a credit bureau at S475. The prospect list includes identification information of each listed person and a creditworthiness requirement associated with each person. As described above, the creditworthiness requirement associated with a person is related to the credit product with which the person is associated. The credit bureau is to determine whether each person satisfies her associated creditworthiness requirement, and the determinations are received at S480.

In some embodiments, the creditworthiness requirements comprise minimum credit scores. Some embodiments of S475 and S480 may therefore comprise forwarding a minimum credit score associated with each determined credit product and person to a credit bureau and receiving a list including each approved person in response. A mailing list of each approved person is then created at S485.

S490 comprises initiating mailing of a mail piece to each person in the mailing list. Some examples of S490 include transmitting mailing list 350 from data servicer 320 to print production servers 360. Print production servers 360 then access printing assets 370 to generate mail pieces based on list 350. Each mail piece includes a firm offer of an associated credit product if required by the Fair Credit Reporting Act.

As a result of process 400, mail pieces such as mail piece 380 or 390 may be transmitted via post to each person in the mailing list.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

The embodiments described herein are solely for the purpose of illustration. Those in the art will recognize other embodiments may be practiced with modifications and alterations limited only by the claims.

What is claimed is:

1. A method comprising:
detecting an event indicating a potential future credit need;
identifying a person based on data associated with the event;
determining a credit product based on the detected event; and
determining whether the person qualifies for the credit product based on a creditworthiness of the person.

2. A method according to claim 1, wherein the event comprises one or more of:
a purchase of an instruction guide, an information inquiry, completion of a design, a service order, or a request for quote.

3. A method according to claim 1, wherein determining the credit product comprises:
determining that the person is not a current holder of the credit product.

4. A method according to claim 1, wherein determining the credit product comprises:
determining that the credit product has not been offered to the person within a prior specified time period.

5. A method according to claim 1, wherein determining whether the person qualifies for the credit product comprises:
determining a creditworthiness requirement associated with the credit product; and
determining whether the creditworthiness of the person satisfies the creditworthiness requirement.

6. A method according to claim 5, wherein determining whether the creditworthiness of the person satisfies the creditworthiness requirement comprises:
providing the creditworthiness requirement and identification information of the person to a credit bureau.

7. A method according to claim 1, further comprising:
offering the credit product to the person.

8. A method according to claim 7, wherein offering the credit product to the person comprises:
initiating mailing of a mail piece to the person, the mail piece including a firm offer of the credit product.

9. A computer-readable medium storing processor-executable process steps, the process steps comprising:
a step to detect an event indicating a potential future credit need;
a step to identify a person based on data associated with the event;
a step to determine a credit product based on the detected event; and
a step to determine whether the person qualifies for the credit product based on a creditworthiness of the person.

10. A medium according to claim 9, wherein the event comprises one or more of:
a purchase of an instruction guide, an information inquiry, completion of a design, a service order, or a request for quote.

11. A medium according to claim 9, the step to determine the credit product comprising:
a step to determine that the person is not a current holder of the credit product.

12. A medium according to claim 9, the step to determine the credit product comprising:
a step to determine that the credit product has not been offered to the person within a prior specified time period.

13. A medium according to claim 9, the step to determine whether the person qualifies for the credit product comprising:
a step to determine a creditworthiness requirement associated with the credit product; and
a step to determine whether the creditworthiness of the person satisfies the creditworthiness requirement.

14. A medium according to claim 13, the step to determine whether the creditworthiness of the person satisfies the creditworthiness requirement comprising:
a step to provide the creditworthiness requirement and identification information of the person to a credit bureau.

15. A medium according to claim 9, the process steps further comprising:
a step to offer the credit product to the person.

16. A medium according to claim 15, wherein the step to offer the credit product to the person comprises:
a step to initiate mailing of a mail piece to the person, the mail piece including a firm offer of the credit product.
